(19) United States
(12) Patent Application Publication
(10) Pub. No.: US 2010/0226783 A1
(43) Pub. Date: Sep. 9, 2010

(54) Erosion and Corrosion Resistant Turbine Compressor Airfoil and Method of Making the Same

(75) Inventors: Jane Marie Lipkin, Niskayuna, NY (US); Krishnamurthy Anand, Karnataka (IN); David Vincent Bucci, Simpsonville, SC (US); Yuk-Chiu Lau, Ballston Lake, NY (US); Surinder Pabla, Greer, SC (US); Vinod Kumar Pareek, Albany, NY (US); Jon Conrad Schaeffer, Simpsonville, SC (US); Guruprasad Sundararajan, Karnataka (IN)

Correspondence Address: CANTOR COLBURN, LLP, 20 Church Street, 22nd Floor, Hartford, CT, 06103, US

(73) Assignee: GENERAL ELECTRIC COMPANY, Schenectady, NY (US)

(21) Appl. No.: 12/399,261

(22) Filed: Mar. 6, 2009

(51) Int. Cl. F01D 5/14; B05D 1/36

(52) U.S. Cl. 416/241 B; 427/404

(57) ABSTRACT

A sacrificial and erosion-resistant turbine compressor airfoil includes a turbine compressor airfoil having a modified airfoil surface. The airfoil surface has an airfoil coating that includes a sacrificial coating comprising a layer of Al, Cr, Zn, an Ni—Al alloy, an Al—Si alloy, an Al-based alloy, a Cr-based alloy or a Zn-based alloy, an Al polymer composite, or a combination thereof, or a layer of a conductive undercoat and an overcoat of an inorganic matrix binder having a plurality of ceramic particles and conductive particles embedded therein disposed on the undercoat. The airfoil coating also includes an sacrificial coating, wherein one of the sacrificial coating or the erosion-resistant coating is disposed on the airfoil surface and the other of the corrosion-resistant coating or the erosion-resistant coating is disposed on the respective one, and wherein the sacrificial coating is more anodic than the airfoil surface or the erosion-resistant coating.

### BACKGROUND OF THE INVENTION

The subject matter disclosed herein relates to turbine compressor airfoils, including turbine compressor airfoils, having improved corrosion and erosion resistance, and methods of manufacturing these turbine compressor airfoils. More particularly, it relates to turbine compressor airfoils having turbine compressor airfoil coatings that provide improved corrosion and erosion resistance, and methods of manufacturing coated turbine compressor airfoils.

Stainless steel turbine compressor airfoils, such as those used in the compressors of industrial gas turbines, have shown susceptibility to water droplet erosion and corrosion pitting of the airfoil surfaces. These are believed to be associated with various electrochemical dissolution processes enabled by the impingement of the water droplets, and other chemical species present in the droplets, intake air or both of them, on the airfoil surface. Electrochemically-induced corrosion and erosion phenomena occurring at the airfoil surfaces can in turn result in cracking of the airfoils due to the cyclic thermal and operating stresses experienced by these components. Water droplet exposure can result from use of on-line water washing, fogging and evaporative cooling, or various combinations of these processes, to enhance compressor efficiency. It can also result from the environments in which the turbines are operating because they are frequently placed in highly corrosive environments, such as those near chemical or petrochemical plants where various chemical species may be found in the intake air, or those at or near ocean coastlines or other saltwater environments where various sea salts may be present in the intake air, or combinations of the above, or in other applications where the inlet air contains corrosive chemical species.

A material change to use other materials for the turbine compressor airfoils, such as nickel-base or titanium-base alloys, is one approach for improving erosion resistance, corrosion resistance, or both, but this may not solve the water droplet erosion or corrosion pitting problems, since these materials may also have susceptibility to the associated electrochemical processes. Further, using materials other than stainless steels to improve the corrosion and erosion resistance of compressor blades is generally not desirable because they are not cost effective replacements, due to the higher cost of the alloy constituents. These materials are generally also not desirable because their use requires redesign of the turbine blades, including the turbine compressor airfoil surfaces, due to the fact that they have different metallurgical and mechanical properties. Further, the use of materials such as nickel-base or titanium-base alloys may not provide better overall robustness of the turbine blades, including turbine compressor airfoils, because they are sensitive to other degradation phenomena, such as various rub and fretting wear mechanisms.

Corrosion resistant airfoil coatings and methods of making steel airfoils with corrosion resistant coatings are described in U.S. Pat. Nos. 5,098,797 and 5,260,099, respectively. These patents describe a corrosion resistant coating that includes a sacrificial undercoat of a metal standing above iron in the electromotive series and a ceramic overcoat that included a mixture of chromium oxide, aluminum oxide and silicon oxide. The ceramic material was applied at a temperature of 600° F. or less to avoid reduction of the fatigue resistance of the type 403 stainless steel airfoil alloy.

While various approaches to improve the erosion or corrosion resistance of stainless steel turbine compressor airfoils have been proposed, stainless steel turbine compressor airfoils having improved resistance to both erosion and corrosion would be desirable.

### BRIEF DESCRIPTION OF THE INVENTION

According to one aspect of the invention, a sacrificial and erosion-resistant turbine compressor airfoil includes a turbine compressor airfoil having an airfoil surface. The airfoil surface has an airfoil coating that includes a sacrificial coating comprising a layer of at least one of Al, Cr, Zn, an Ni—Al alloy, an Al—Si alloy, an Al-based alloy, a Cr-based alloy or a Zn-based alloy, an Al polymer composite, or a combination thereof, or a layer of a conductive undercoat and an overcoat of an inorganic matrix binder having a plurality of ceramic particles and conductive particles embedded therein disposed on the undercoat. The airfoil coating also includes an erosion-resistant coating, wherein one of the sacrificial coating or the erosion-resistant coating is disposed on the airfoil surface and the other of the sacrificial coating or the erosion-resistant coating is disposed on the respective one, and wherein the sacrificial coating is more anodic than the airfoil surface or the erosion-resistant coating.

According to another aspect of the invention, a method of making a sacrificial and erosion-resistant turbine compressor airfoil includes providing a turbine compressor airfoil having a modified airfoil surface. The method also includes disposing one of a sacrificial coating or an erosion-resistant coating on the airfoil surface, the sacrificial coating comprising a layer of at least one of Al, Cr, Zn, an Ni—Al alloy, an Al—Si alloy, an Al-based alloy, a Cr-based alloy or a Zn-based alloy, an Al polymer composite, or a combination thereof, or a layer of a conductive undercoat and an overcoat of an inorganic matrix binder having a plurality of ceramic particles and conductive particles embedded therein disposed on the undercoat. The method also includes disposing the other of the sacrificial coating or the erosion-resistant coating on the respective one that is disposed on the airfoil surface, wherein the sacrificial coating is more anodic with reference to the airfoil surface than the erosion-resistant coating.

These and other advantages and features will become more apparent from the following description taken in conjunction with the drawings.

### BRIEF DESCRIPTION OF THE DRAWING

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is perspective view of a turbine compressor airfoil, in the form of a turbine blade, as disclosed herein;

FIG. 2 is a cross-sectional view of section 2-2 of FIG. 1;

FIG. 3. is a cross-sectional view of an embodiment of region 90 of FIG. 2;

FIG. 4. is a cross-sectional view of a second embodiment of region 90 of FIG. 2;

FIG. 5 is a cross-sectional view of a third embodiment of region 90 of FIG. 2;

FIG. 6 is a cross-sectional view of a fourth embodiment of region 90 of FIG. 2;

FIG. 7 is a cross-sectional view of a fifth embodiment of region 90 of FIG. 2;

FIG. 8 is a plot illustrating the erosion and corrosion performance of various turbine compressor airfoils, as disclosed herein;

FIG. 9 is a plot of electrochemical potential as a function of current for an embodiment of a turbine compressor airfoil as disclosed herein; and

FIG. 10 is a plot of electrochemical potential and monitored corrosion current as a function of time for a test pin representative of an embodiment of a turbine compressor airfoil as disclosed herein.

The detailed description explains embodiments of the invention, together with advantages and features, by way of example with reference to the drawings.

### DETAILED DESCRIPTION OF THE INVENTION

A sacrificial and erosion-resistant turbine compressor airfoil is disclosed having an airfoil surface and an airfoil coating disposed thereon. The airfoil coating includes a sacrificial coating and an erosion-resistant coating, and is particularly useful for turbine compressor airfoil applications, including rotating compressor blades, stationary compressor vanes, shrouds and other airfoil surfaces within the turbine that may be subject to water droplet erosion and pitting and crevice corrosion. One of the sacrificial coating or the erosion-resistant coating is disposed on the airfoil surface and the other of the sacrificial coating or the erosion-resistant coating is disposed on the respective one. The -sacrificial coating is more anodic with reference to the airfoil surface than the erosion-resistant coating. The coating system provides enhanced water droplet erosion protection, enhanced galvanic and crevice corrosion resistance, and improved surface finish and antifouling capability for turbine compressor airfoil applications. The coating system takes advantage of the excellent solid particle and water droplet erosion resistance of TiN or a WCCoCr alloy, including multilayer Ti/TiN structures where the layers of Ti and TiN are placed in an alternating arrangement. The coating system also takes advantage of the excellent galvanic corrosion resistance provided by at least one layer of Al, Cr, Zn, an Al-based alloy, a Cr-based alloy, or a Zn-based alloy, or a combination thereof; or a layer of a conductive undercoat and an overcoat of a ceramic material disposed on the undercoat. Both single and multi-layer systems have been found to be water droplet erosion resistant. It has been discovered that the coatings protect the substrate in erosive and corrosive environments. The coatings may be strategically placed and coating thicknesses designed to provide specific water droplet erosion and pitting corrosion benefits for turbine compressor airfoil applications.

As used herein, the term “comprising” means various compositions, compounds, components, layers, steps and the like can be conjointly employed in the present invention. Accordingly, the term “comprising” encompasses the more restrictive terms “consisting essentially of” and “consisting of.”

The embodiments of the turbine compressor airfoils 1 disclosed herein have improved particle impact and water droplet erosion resistance and crevice corrosion resistance. They include turbine compressor airfoils 1 that can be removably attached to a central hub or disk, as well as turbine compressor airfoils 1 integral with the hub or disk, i.e., a turbine blisk. However, while the embodiments herein are illustrated with reference to turbine compressor airfoils 1 in the form of turbine blades 10, they are broadly applicable to all manner of turbine compressor airfoils 1 used in a wide variety of turbine engine components. These include turbine compressor airfoils 1 associated with turbine vanes 100 and nozzles, shrouds 200, combustor liners 300 and other 400 turbine compressor airfoils, i.e., turbine components having airfoil surfaces such as diaphragm components, seal components, valve stems, nozzle boxes, nozzle plates, or the like.

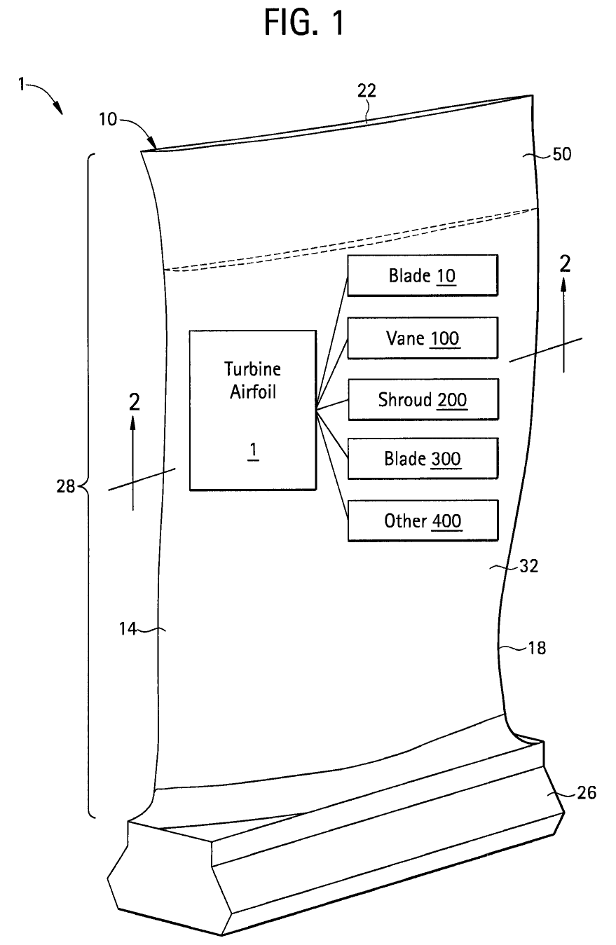

Referring to FIG. 1, a typical turbine compressor airfoil 1 in the form of turbine compressor blade 10 is illustrated. Blade 10 has a leading edge 14, a trailing edge 18, a tip edge 22 and a blade root 26. The span 28 of blade 10 extends from tip edge 22 to blade root 26. The surface of blade 10 comprehended within the span 28 constitutes the airfoil surface 32 of turbine compressor airfoil 1. Airfoil surface 32 is that portion of turbine compressor airfoil 1 that is exposed to the flow path of air from the turbine inlet (not shown) through the compressor section of the turbine into the combustion chamber and other portions of the turbine.

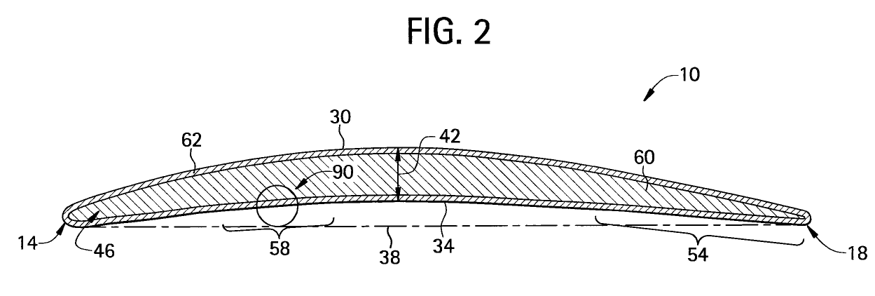

FIG. 2 shows the convex curved surface or suction side 30 and the concave curved surface or pressure side 34 of blade 10 that extend between leading edge 14 and trailing edge 18. The dashed line indicated by 38 that extends from the leading edge 14 to the trailing edge 18 defines the width or chord of blade 10. The double-headed arrow indicated by 42 between suction side 30 and pressure side 34 defines the thickness (usually measured as the “maximum” thickness) of blade 10.

Referring to FIG. 2, the leading edge section 46 of blade 10 is where the greatest erosion and corrosion damage of airfoil surface 32 tends to occur, particularly with regard to the initiation of erosion or corrosion pitting, especially at or proximate to leading edge 14. Referring to FIGS. 1 and 2, the area of greatest erosion damage tends to occur in the tip edge portion 50 or area of span 28, especially at or proximate to tip edge 22, and also tends to be focused in the portion 54 or area of pressure side 34 that is directly forward of trailing edge 18 and to a lesser extent in the portion 58 or area of pressure side 34 that is directly aft of leading edge 14. The sacrificial and erosion-resistant coatings described here may be disposed over all or any portion of the airfoil surface 32, but are particularly suited for disposition on the portion of airfoil surface 32 that are most susceptible to corrosion and erosion, as described above.

Turbine compressor airfoils 1 may be made from various stainless steels and superalloys. Superalloys include metallic alloys that can be used at high temperatures, often in excess of about 0.7 of the absolute melting temperature. Any Fe-based, Co-based or Ni-based based superalloy composition may be used to form the turbine compressor airfoils 1. The most common solutes in Fe-based, Co-based or Ni-based superalloys are aluminum and/or titanium. Generally, the aluminum and/or titanium concentrations are low (e.g., less than or equal to about 15 weight percent (wt %) each). Other optional components include chromium, molybdenum, cobalt (in Fe-based or Ni-based superalloys), tungsten, nickel (in Fe-based or Co-based superalloys), rhenium, iron (in Co-based or Ni-based superalloys), tantalum, vanadium, hafnium, columbium, ruthenium, zirconium, boron, yttrium, and carbon, each of which may independently be present in an amount of less than or equal to about 15 wt %. Turbine compressor airfoils 1 may be made from various grades of stainless steel, including both 300 series and 400 series stainless steels. More particularly, turbine compressor airfoils 1 may comprise type 450 stainless steel, a martensitic, age-hardenable alloy comprising, by weight, 0.05% carbon, 1.00% manganese, 0.030% phosphorous, 0.030% sulfur, 1.00% silicon, 14.00 to 16.00% chromium, 5.00 to 7.00% nickel, 0.50 to 1.00% molybdenum, 1.25 to 1.75% copper, 0.35 to 0.75% niobium (columbium), and the balance (approximately 72.14 to 77.14%) iron and impurities.

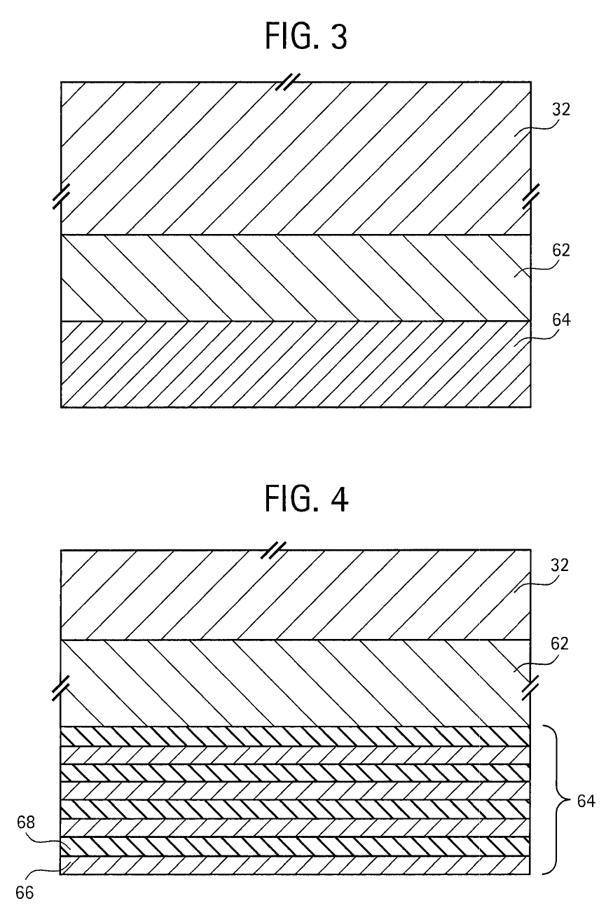

The airfoil surface 32 is the surface associated with base segment or substrate 60 of blade 10. As also shown in FIGS. 3-7 to prevent erosion and corrosion or enhance erosion resistance and corrosion resistance, a multilayer airfoil coating 61 includes at least one sacrificial coating 62 and at least one erosion-resistant coating 64 disposed on airfoil surface 32 of base segment 60. These layers may be disposed on airfoil surface 32 in any order, such that sacrificial coating 62 may be disposed on airfoil surface 32, with erosion-resistant coating 64 being disposed on the surface of sacrificial coating 62. Alternately, an opposite ordering may be used, such that erosion-resistant coating 64 may be disposed on airfoil surface 32, with sacrificial coating 62 is disposed on the surface of erosion-resistant coating 64. Airfoil coating 61 may also include a plurality of sacrificial layers 62 interspersed within a plurality of erosion-resistant layers 64, such as in all manner of alternating arrangements or sequences, e.g., 62/64/62/64/62/64, 62/64//62.1, 64/62/62.1/64, 62/62.1/62.2/64, 62/62.1/64/62.1/64 and the like, where differences in the tenths digits are used to indicate changes in the sacrificial coating 62 materials and the erosion-resistant-coating 64 materials. Hence, the structure may be described generally as a turbine compressor airfoil having an airfoil surface 32, a sacrificial coating 62, and an erosion-resistant coating 64, wherein one of the sacrificial coating 62 or the erosion-resistant coating 64 is disposed on the airfoil surface and the other of the sacrificial coating 62 or the erosion-resistant coating 64 is disposed on the respective one. Airfoil coating 61 may have any thickness that is effective for providing a predetermined amount of corrosion-resistance and erosion-resistance, including the sum or sums of those described below for the sacrificial coatings and erosion-resistant coatings. Airfoil coating 61 is selected such that it imparts suitable corrosion-resistance, particularly with regard to galvanic and crevice corrosion, and erosion resistance, particularly with regard to water droplet erosion, properties to blade 10 at least in the portions or areas 54 and 58 of pressure side 34, typically over the entire or substantially the entire area of pressure side 34, and more typically over the entire or substantially the entire area of pressure side 34 and suction side 30.

The sacrificial coating 62 is so named because it is anodic relative to the airfoil surface 32. It is also more anodic with reference to the airfoil surface 32 than the erosion-resistant coating 64, hence that sacrificial coating 62 is also anodic relative to erosion-resistant coating 64. Therefore, sacrificial coating 62 is selected so that it is more anodic than either airfoil surface 32 and base segment 60 or erosion-resistant coating 64. By more anodic, it is meant that the electromotive force (emf) or corrosion potential with respect to a standard thermodynamic reference potential of the sacrificial coating 62 is more negative than that of either airfoil surface 32 or erosion-resistant coating 64 in a corrosive (reactant) species to which turbine compressor airfoil 1 is exposed. With regard to water droplet erosion, this may include potential reactant species associated with water droplets deliberately introduced into the turbine, including those resulting from on-line water washing, fogging and evaporative cooling, or various combinations thereof. Reactant species can also result from environments in which the turbines are operating because they are frequently placed in highly corrosive environments, such as those near chemical or petrochemical plants where various chemical species may be found in the intake air, or those at or near ocean coastlines or other saltwater environments where various sea salts, minerals and other seawater constituents may be present in the intake air, or combinations of the above, or in other applications where the inlet air contains corrosive chemical species. These species may be ingested together with water droplets from the external environment, or may mix with water droplets that are deliberately introduced, as described above. Without limitation, these species may include various ionic species, including those comprising, Cl⁻, Br⁻, F⁻, S²⁻, and others. Together with the water droplets, these species are capable of participating in various electrochemical reactions and thereby causing electrochemical erosion and corrosion of the airfoil surface 32. By use of the airfoil coating 61, sacrificial coating 62, by virtue of its being electrochemically more anodic than airfoil surface 32 and erosion-resistant coating 64, is configured to be attacked preferentially to airfoil surface 32.

Reference herein to the sacrificial coating 62 being disposed on either the airfoil surface 32 or erosion-resistant coating 64 means that it is attached and tightly adherent to these surfaces, preferably by virtue of chemical or metallurgical bonding, such that it is able to undergo normal operating and thermal stresses without exhibiting spalling or other coating degradation processes. Airfoil surfaces 32 are commonly treated to produce a residual compressive surface stress in order to reduce the tendency of any cracks or pits (or other features that might tend to cause a stress riser at the surface) from propagating from the surface into the interior of the airfoil. Residual compressive stresses may be imparted to airfoil surfaces 32 by shot peening, laser peening or other treatments that also produce residual compressive stresses, or other methods. Airfoil coating 61 may also be disposed so as to include residual compressive stresses, particularly compressive stresses that are greater than those of the airfoil surface 32, particularly where airfoil surface 32 includes residual compressive stresses 32. As an example, a sacrificial coating 62 comprising TiN may have a residual compressive stress of about 3792 MPa. The turbine compressor airfoils 1 has an airfoil surface 32 with a first residual compressive stress (σ₁), the respective one of the sacrificial coating or the erosion-resistant coating has a second residual compressive stress (σ₂), and the other of the sacrificial coating or the erosion-resistant coating has a third residual compressive stress (σ₃), wherein σ₃>σ₂>σ₁.

Sacrificial coating 62 may include any suitable coating material comprising Al, Cr, Zn, an Al-based alloy, a Cr-based alloy, or a Zn-based alloy, or a combination thereof, that is more anodic than the airfoil surface 32 or the erosion-resistant coating 64, as described above, and also include various glasses, ceramics, polymers and composites, in any combination, that include these materials. More particularly, in an exemplary embodiment sacrificial coating 62 may include a layer comprising Al, Cr, Zn, an Ni—Al alloy, an Al—Si alloy, an Al-based alloy, a Cr-based alloy or a Zn-based alloy, an Al particle polymer composite, or a combination thereof. This includes the use of these materials in particulate or other forms in various paints and composite materials, including those comprising various polymeric materials, including metal particle pigmented paints, such as aluminum particle pigmented paints having an aluminum content of about 70% or more, by weight.

The sacrificial layer 62 may be disposed either on the airfoil surface 32 or over the erosion-resistant coating 64, but is particularly suited to being disposed on the airfoil surface 32, as this arrangement places the anodic material in direct electrical contact with the airfoil surface 32, thereby assuring anodic protection of this surface. The sacrificial layer 62 may be disposed as a thin film or thick film layer by any suitable application or deposition method, including plating (electro and electroless plating), dipping, spraying, painting, chemical vapor deposition (CVD), or physical vapor deposition (PVD), such as EB-PVD, filtered arc deposition, and more typically by sputtering. Suitable sputtering techniques for use herein include but are not limited to direct current diode sputtering, radio frequency sputtering, ion beam sputtering, reactive sputtering, magnetron sputtering and steered arc sputtering. Sacrificial coating 62 may include a single layer, or may be provided in multiple layers, including a sacrificial layer that includes a plurality of different materials as sub-layers disposed in a contiguous fashion to form a sacrificial layer 62. In a single layer configuration, sacrificial coating 62 may have any suitable thickness needed to provide anodic protection of the airfoil surface 32, including to obtain a predetermined or design service life. For example, the thickness of sacrificial coating 62 in the form of a thick film, such as a metal particle/polymer matrix paint, may range from about 120 to 730 microns. The thickness of sacrificial coating 62 deposited using a thin film deposition method will generally have a higher density and a thickness in the range of about 5 to 50 microns.

In another exemplary embodiment, sacrificial coating 62 may include a layer of a conductive undercoat and an overcoat of an inorganic binder having a plurality of ceramic particles and conductive particles embedded therein disposed on the undercoat, as described in U.S. Pat. Nos. 5,098,797 and 5,260,099. In particular, the conductive undercoat may include a continuous, relatively thin, sacrificial metal layer, such as a layer of a nickel cadmium alloy. The nickel cadmium layer may be electroplated to a thickness of about 5 to 10 microns, preferably about 7.6 mils. Alternately, the sacrificial metal undercoat may be provided by flame or plasma spraying techniques in common use, or preferably by applying a metallic paint, such as an aluminum particle/polymer matrix paint, as described above. When using the metallic paint, the airfoil surface may be initially prepared by grit blasting and then drying, heating to cure and then consolidating the metal powder in contact with the airfoil surface, such as consolidation by glass bead blasting. Generally, a single application will be sufficient to produce an adequate undercoat of the metallic paint having a thickness in the range described above. The overcoat is disposed on the underlayer and includes an inorganic matrix binder having a plurality of ceramic particles and conductive particles embedded therein. In one embodiment, the inorganic matrix binder includes a phosphate chromate binder having a plurality of aluminum oxide and chromium oxide ceramic particles and aluminum metal particles embedded therein. The binder may also include cobalt and other metal or conductive particles. The overcoat may be made using the methods disclosed in U.S. Pat. No. 3,248,251. The amount of the embedded metal particles may be selected to make the overcoat more anodic than the airfoil surface 32 or the erosion-resistant layer 64. The overcoat may be deposited in any suitable thickness. In one embodiment, where the inorganic matrix binder is a phosphate chromate binder, having aluminum oxide and chromium oxide ceramic particles and aluminum metal particles embedded therein, the thickness of the overcoat may be about 3 mils or more. In this embodiment, where the sacrificial coating 62 includes a conductive undercoat/overcoat, the sacrificial layer 62 may be disposed either on the airfoil surface 32 or over the erosion-resistant coating 64, but is particularly suited to being disposed on the surface of the erosion-resistant coating 64, as the sacrificial coating 62 also provides erosion-resistance due to the abrasion resistance associated with and provided by the ceramic material overcoat.

As noted above, the erosion-resistant coating 64 portion of airfoil coating 61 may be disposed either on airfoil surface 32 or on the surface of sacrificial coating 62, i.e., either above or under sacrificial coating 62. The erosion-resistant layer 64 or layers includes a hard, erosion-resistant layer of a ceramic or a cermet, or a combination thereof. Where the sacrificial coating 62 includes a conductive undercoat/overcoat as described above, such as the phosphate chromate inorganic matrix binder, the overcoat may also provide some erosion-resistance to the airfoil coating 61 due to the hardness and abrasion resistance of the embedded ceramic particles; however, the phosphate chromate ceramic overcoat alone is not suitable for use as the erosion-resistant layer 64, as disclosed herein, because it does not provide sufficient erosion-resistance owing to its more porous morphology.

As noted, airfoil coating 61 may include a ceramic material as erosion-resistant coating 64. Suitable ceramic compositions include metal oxides such as Al₂O₃, Cr₂O₃, Y₂O₃, ZrO₂, CeO₂, TiO₂, Ta₂O₅, TaO₂, and the like; metal carbides such as Cr₃C₂, WC, TiC, ZrC, B₄C, and the like; diamond, diamond-like carbon; metal nitrides such as BN, TiN, ZrN, HfN, CrN, Si₃N₄, AlN, TiAlN, TiAlCrN, TiCrN, TiZrN, and the like; metal borides such as TiB₂, ZrB₂, Cr₃B₂, W₂B₂, and the like; and combinations comprising at least one of the foregoing compositions (e.g., TiCN, CrBN, TiBN, and the like). Alternately, the erosion-resistant coating 64 can comprise a ceramic-metal composite (cermet), including those that may be characterized as a metal matrix composite. Suitable cermets include WC/Co, WC/CoCr, WC/Ni, TiC/Ni, TiC/Fe, Ni(Cr)/Cr₃C₂, TaC/Ni, and combinations comprising at least one of the foregoing. In the case of WC—Co cermets, suitable compositions include those comprising, in weight percent, 12-20% Co and the balance WC. In the case of WC—CoCr cermets, suitable compositions include those comprising, in weight percent, 6-10% Co, 4-8% Cr and the balance WC. Still other embodiments of the erosion-resistant coating 64 include combinations comprising at least one of the ceramics or cermets (e.g., a metal or alloy matrix of one of the foregoing). This may also include an erosion-resistant coating 64 that has multiple erosion-resistant layers of the same or different erosion-resistant materials, including those that also include interspersed metal layers to promote adherence of the multilayer structure into a cohesive erosion-resistant coating 64. For many of these materials, Cr, Ti or Ta may be used to form strongly adherent interspersed metal layers, particularly where one of these metals is a constituent of the ceramic or cermet, but other metals may also be used. For example, a multilayer erosion resistant coating 64 that includes a plurality of layers of Ti and TiN in an alternating arrangement, including any sequential or non-sequential alternating arrangement, such as, for example, Ti/TiN/Ti/TiN/ . . . /Ti/TiN, or TiN/Ti/TiN/Ti . . . /TiN/Ti, or TiN/Ti/TiN/Ti/ . . . /Ti/TiN, or Ti/TiN/Ti/TiN . . . /Ti/TiN/Ti. Of the erosion-resistant ceramic and cermet materials, single layers TiN or WCCoCr, or a multilayer structure that includes a plurality of layers of Ti and TiN, have been tested and are particularly suitable for use as erosion-resistant coating 64. In the case of both the ceramic and cermet materials mentioned above, the composition may be the stoichiometric compositions shown, as well as various non-stoichiometric variants. For example, non-stoichiometric compositions may be employed to introduce residual compressive stress into the crystal lattice, and may be deposited using known methods for their deposition.

Any suitable thickness of a single layer and a multilayer erosion-resistant coating 64 may be used, so long as it is effective to provide increased erosion resistance over that of the material of airfoil surface 32. In one embodiment, for a single layer of TiN, an effective layer thickness includes a minimum thickness of about 5 microns, and single layer thickness in the range of 5-10 microns, and a residual compressive stress of at least about 3792 MPa. In another embodiment of a multilayer that includes a plurality of Ti and TiN layers in an alternating arrangement, a minimum thickness per layer of about 5 microns and a maximum overall thickness of about 60 microns (with at least four layers of Ti and TiN ) is effective. An effective thickness range for at least one Ti/TiN combination, and more preferably four or more Ti and TiN layers, is about 5-60 microns, and more particularly about 25-60 microns, and even more particularly about 45-60 microns. In yet another exemplary embodiment of a single layer of WCCoCr as the erosion-resistant coating 64, an effective layer thickness includes a minimum thickness of about 3 mils and single layer thickness in the range of 3-7 mils, and a residual compressive stress of at least about 3792 MPa. The minimum thickness will be that effective to provide erosion-resistance greater than that of the bare airfoil surface 32, which generally will be a layer thickness sufficient to insure complete coverage of the surface, including features such as film-cooling holes, etc., while avoiding coating defects sometimes associated with thin layers, such as pinholes. The maximum thickness may be any suitable thickness, but will generally be a thickness that is effective to provide a desired service life to the airfoil surface in a predetermined operating environment, while also maintaining a desired level of adherence or bond strength to the airfoil surface 32 or sacrificial coating 62 to which it is applied, as the case may be. The maximum thickness will typically be a function of the method used to dispose the erosion-resistant material on the airfoil surface 32 or the sacrificial coating 62, the associated sacrificial coating 62 used and the overall minimum amount of residual compressive stress desired within airfoil coating 61. A minimum amount of overall residual compressive stress is desirable in airfoil coating 61 and erosion-resistant coating 64, generally an amount that is at least as large as any minimum amount of residual compressive stress imparted to the airfoil surface 32, so that the airfoil coating 61 does not have the effect of decreasing the residual compressive stress in the airfoil surface 32 below the desired minimum amount, and so that the airfoil coating 61 also maintains the desired minimum amount of residual compressive stress.

The airfoil coatings 61, including those that include an erosion-resistant coating 64 having a plurality of alternating ceramic (or cermet) and metallic layers, are typically formed by physical vapor deposition (PVD), such as EB-PVD, filtered arc deposition, and more typically by sputtering. Suitable sputtering techniques for use herein include but are not limited to direct current diode sputtering, radio frequency sputtering, ion beam sputtering, reactive sputtering, magnetron sputtering and steered arc sputtering. In forming the ceramic layers that include carbides or nitrides, deposition is typically carried out in an atmosphere comprising a source of carbon (e.g., methane) or a source of nitrogen (e.g., nitrogen gas), respectively. In the case of borides, a source or target material that includes the metal borides to be deposited may be used. In forming the metallic layers, sputtering is typically carried out in an inert atmosphere.

Several embodiments of an airfoil 10 having an airfoil surface 32 and an airfoil coating 61 disposed are illustrated in FIGS. 3-6. The airfoil coating 61 includes a sacrificial coating 62 and an erosion-resistant coating 64 of the types described herein, where the sacrificial coating 62 is more anodic than either the airfoil surface 32 or erosion-resistant coating 64.

Referring to FIG. 3, a first embodiment of an airfoil 10 and airfoil surface 32 has sacrificial coating 62 disposed on the airfoil surface 32 that includes a layer of Al, Cr, Zn, an Ni—Al alloy, an Al—Si alloy, an Al-based alloy, a Cr-based alloy or a Zn-based alloy, an Al polymer composite, or a combination thereof. Disposed on sacrificial coating 62 is an erosion-resistant coating 64 that includes a layer of a ceramic or cermet 66 material as described herein, such as TiN. The sacrificial coating 62 is more anodic than the airfoil surface 32 or the erosion-resistant coating 64, as described above.

Referring to FIG. 4, a second embodiment of an airfoil 10 and airfoil surface 32 has sacrificial coating 62 disposed on the airfoil surface 32 that includes a layer of Al, Cr, Zn, an Ni—Al alloy, an Al—Si alloy, an Al-based alloy, a Cr-based alloy or a Zn-based alloy, an Al polymer composite, or a combination thereof. Disposed on sacrificial coating 62 is an erosion-resistant coating 64 that includes a multilayer having an alternating arrangement of metal 68 layers and ceramic (or cermet) 66 layers, as described herein, such as alternating layers of Ti and TiN. The sacrificial coating 62 is more anodic than the airfoil surface 32 or the erosion-resistant coating 64, as described above.

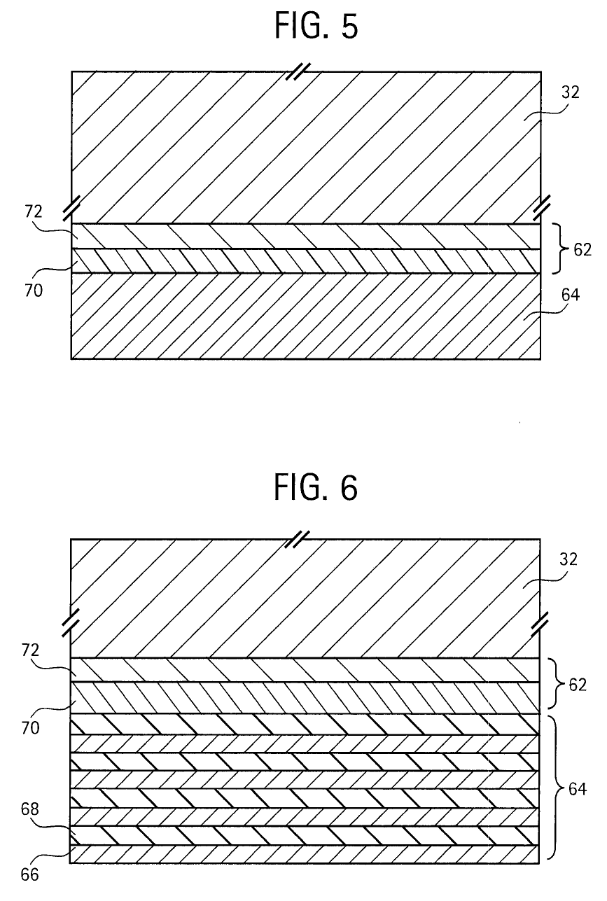

Referring to FIG. 5, a third embodiment of an airfoil 10 and airfoil surface 32 has sacrificial coating 62 disposed on the airfoil surface 32 that includes a layer of a conductive undercoat and an overcoat of an inorganic matrix binder having a plurality of ceramic particles and conductive particles embedded therein disposed on the undercoat. Disposed on sacrificial coating 62 is an erosion-resistant coating 64 that includes a layer of a ceramic or cermet 66 material as described herein, such as TiN. The sacrificial coating 62 is more anodic than the airfoil surface 32 or the erosion-resistant coating 64, as described above.

Referring to FIG. 6, a fourth embodiment of an airfoil 10 and airfoil surface 32 has sacrificial coating 62 disposed on the airfoil surface 32 that includes a layer of a conductive undercoat and an overcoat of an inorganic matrix binder having a plurality of ceramic particles and conductive particles embedded therein disposed on the undercoat. Disposed on sacrificial coating 62 is an erosion-resistant coating 64 that includes a multilayer having an alternating arrangement of metal 68 layers and ceramic (or cermet) 66 layers, as described herein, such as alternating layers of Ti and TiN. The sacrificial coating 62 is more anodic than the airfoil surface 32 or the erosion-resistant coating 64, as described above.

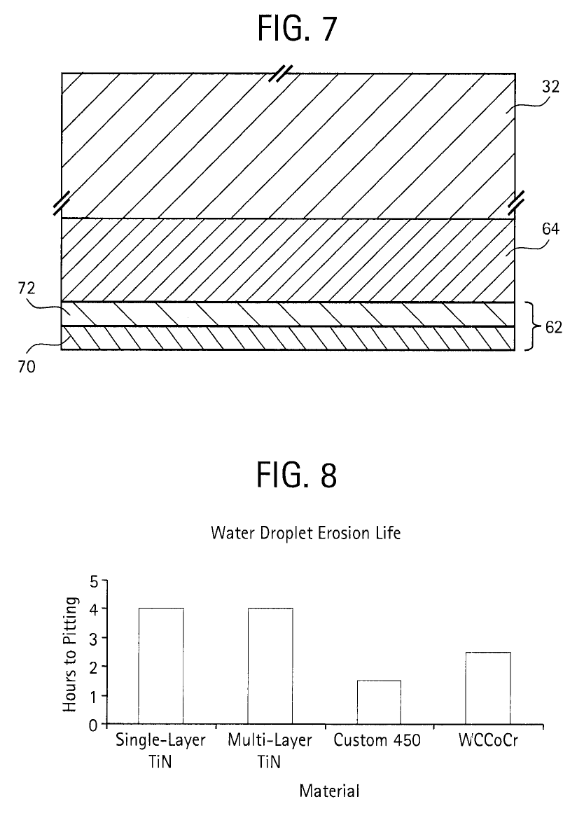

Referring to FIG. 7, a fifth embodiment of an airfoil 10 and airfoil surface 32 has erosion-resistant coating 64 disposed on the airfoil surface 32 that includes a multilayer having an alternating arrangement of metal 68 layers and ceramic (or cermet) 66 layers, as described herein, such as alternating layers of Ti and TiN. Disposed on erosion-resistant coating 64 is a sacrificial coating 62 that includes a layer of a conductive undercoat and an overcoat of an inorganic matrix binder having a plurality of ceramic particles and conductive particles embedded therein disposed on the undercoat, such as an undercoat layer of a conductive Al paint that includes Al particles in a polymer matrix, and an overcoat layer having a inorganic matrix of a phosphate-chromate ceramic with aluminum oxide, chromium oxide and aluminum particles embedded therein. The sacrificial coating 62 is more anodic than the airfoil surface 32 or the erosion-resistant coating 64, as described above.

While the turbine compressor airfoils 1 disclosed herein have been described above with particular reference to an embodiment of a turbine blade 10. Turbine compressor airfoils 1 having an airfoil coating 32 that includes an erosion-resistant coating 64 and sacrificial coating 62 of the types described herein may also include airfoils associated with other turbine components having airfoil surfaces that may be subject to water droplet erosion or crevice corrosion as described herein. These include turbine vanes 100, shrouds 200, combustor liners 300 and other components 400 having airfoil surfaces, as illustrated in FIG. 1. The turbine compressor airfoils disclosed herein may be understood by reference to the following examples.

### EXAMPLE 1

Water droplet erosion testing was used to simulate the water impact on the compressor components in the turbine during water wash and water spritz power augmentation. Particle velocity and droplet sizes were controlled to best replicate the turbine environment. A series of cylindrical test coupons of Custom 450 stainless steel were coated with several erosion-resistant coatings including a single layer of TiN having a thickness of about 6 to 8 microns, a multilayer of a plurality Ti and TiN, each having a minimum thickness of 5 microns and having an overall thickness of about 45 microns, and a layer of WC—CoCr having a composition, in weight percent, of 10% Co, 4% Cr and the balance WC and a thickness of about 4-6 mils. Test coupons having these erosion-resistant coatings were tested in a rotary test fixture where the test coupons were attached to the outboard end of the leading edge of a motor-driven five-foot blade. The apparatus was designed to rotate the blade and test coupons through a continuous spray of water droplets with a DV90 of 740 microns at a speed of 800 feet/sec. The tests were run until the onset of erosive pitting was observed and the time to pitting was noted. The results are shown in FIG. 8. The test demonstrated that the erosion-resistant coatings were effective to improve the water droplet erosion-resistance of Custom 450 stainless steel. All of the erosion-resistant coatings showed a substantial improvement in erosion resistance relative to the bare Custom 450 surface.

### EXAMPLE 2

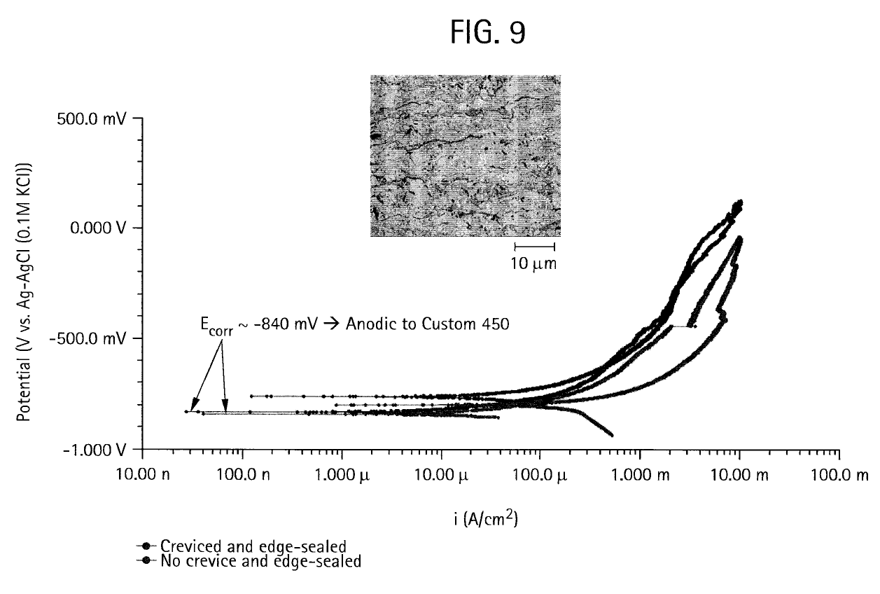

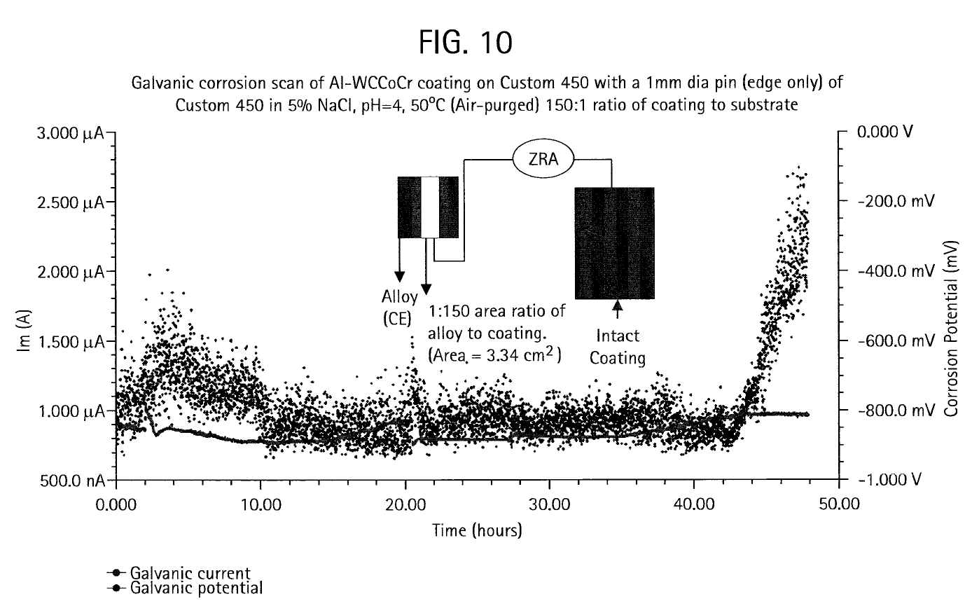

In a second test, polarization scans and galvanic corrosion tests were performed on Custom −450 test coupons coated with the airfoil coatings described herein. A series of test coupons of Custom 450 stainless steel were coated with an airfoil coating including a sheet of Custom 450 as the airfoil surface, a 50 micron thick coating of Al deposited by an air plasma spray (APS) process and a 150 micron thick coating of WC—CoCr deposited by Hyper-velocity oxy-fuel (HVOF) spray process. The test conditions included 5% NaCl (similar to salt-fog chloride levels), that was acidic having a pH=4.0 at 50 degree Celsius to simulate condensing gases with moisture and salt. The test was an accelerated corrosion test for assessing coating performance. It utilized a cyclic polarization corrosion test according to ASTM G61 with creviced Custom 450 coupons. Ceramic washers torqued down by associated threaded bolts to 40 in-lb were used for crevicing the test coupons. Absence of hysteresis in the cyclic polarization loop and a post-examination photomicrograph of the test coupon, as shown in FIG. 9, revealed the absence of any crevice corrosion, and visual examination revealed no red rust or other evidence that corrosion of Custom 450 occurred during the cyclic polarization scan. The corrosion potential or potential under steady-state unpolarized (actual operating) conditions for this coating system is ˜−840 mV. This is about 550 mV below the corrosion potential or E_{corr} of bare Custom 450 exposed to 5% NaCl, under similar pH and temperature conditions which is about −300 mV. Hence the coating system is said to be anodic or sacrificial relative to the Custom 450 substrate in acidic chloride media. Hence such a system that includes a sacrificial coating (Al) and an erosion-resistant coating (WC—CoCr) is suitable for providing erosion and corrosion resistance in a turbine compressor airfoil environment. Both creviced and un-creviced coupon showed similar polarization behavior, namely absence of crevice corrosion and similar corrosion rates. In another experiment, the above coating system was externally shorted electrically to a Custom 450 pin edge and both were exposed to a similar 5% NaCl solution at pH=4.0 and 50° C. The area ratios of the above coating system and the Custom 450 pin edge was kept at 150:1 in order to simulate defects in the actual coating system that would be exposed to field conditions. Due to difference in electrochemical corrosion potentials of Custom 450 and the two-layer coating system, currents would flow through the external circuit as they were shorted and the current levels were monitored through a Zero Resistance Ammeter (ZRA). The galvanic potential between the coating and the substrate were also monitored and was near −850 mV vs. Ag—Ag—AgCl reference electrode. From FIG. 10, it can be seen that a steady state current of about 1.0 micro amps were monitored between the coating and the Custom 450 pin substrate. Based on the positive current magnitude and the direction, the coating is sacrificial in that the coating corrodes preferentially to the substrate. Thus, even in field conditions, the coating would protect the substrate against galvanic corrosion even if there is a breach of the coating to an extent that would allow corrosive species to reach the substrate.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A turbine compressor airfoil, comprising:
a turbine compressor airfoil having an airfoil surface;
a sacrificial coating comprising a layer of Al, Cr, Zn, an Ni—Al alloy, an Al—Si alloy, an Al-based alloy, a Cr-based alloy or a Zn-based alloy, an Al polymer composite, or a combination thereof, or a layer of a conductive undercoat and an overcoat of an inorganic matrix binder having a plurality of ceramic particles and conductive particles embedded therein disposed on the undercoat; and
an erosion-resistant coating, wherein one of the sacrificial coating or the erosion-resistant coating is disposed on the airfoil surface and the other of the sacrificial coating or the erosion-resistant coating is disposed on the respective one, and wherein the sacrificial coating is more anodic than the airfoil surface or the erosion-resistant coating.

2. The turbine compressor airfoil of claim 1, wherein the airfoil surface comprises a stainless steel or a superalloy.

3. The turbine compressor airfoil of claim 1, wherein the erosion-resistant coating comprises a layer of a ceramic or a cermet.

4. The turbine compressor airfoil of claim 3, wherein the erosion-resistant coating is a ceramic comprising a metal oxide, nitride, carbide, boride, carbonitride, oxynitride, boronitride, diamond, diamond-like carbon, or a combination thereof.

5. The turbine compressor airfoil of claim 3, wherein the erosion-resistant coating comprises a layer of Al₂O₃, Cr₂O₃, Y₂O₃, ZrO₂, CeO₂, TiO₂, Ta₂O₅, TaO₂, Cr₃C₂, WC, TiC, ZrC, B₄C, diamond, diamond-like carbon, BN, TiN, ZrN, HfN, CrN, Si₃N₄, AlN, TiAlN, TiAlCrN, TiCrN, TiZrN, TiB₂, ZrB₂, Cr₃B₂, W₂B₂, TiCN, CrBN, TiBN, WC—Co, WC—CoCr, WC—Ni, TiC—Ni, TiC—Fe, Ni(Cr)—Cr₃C₂, or TaC—Ni, or a combination thereof.

6. The turbine compressor airfoil of claim 5, wherein the erosion-resistant coating is a single layer of the ceramic or the cermet.

7. The turbine compressor airfoil of claim 6, further comprising a layer of a metal disposed under the layer of the ceramic or the cermet.

8. The turbine compressor airfoil of claim 6, wherein the erosion-resistant coating further comprises a plurality of metal layers and a plurality of ceramic or cermet layers.

9. The turbine compressor airfoil of claim 8, wherein the metal layers and the ceramic or cermet layers have an alternating arrangement.

10. The turbine compressor airfoil of claim 8, wherein the metal layers comprise Ti and the ceramic or cermet layers comprise TiN layers.

11. The turbine compressor airfoil of claim 3, wherein the erosion-resistant coating comprises a layer of a WCCoCr alloy.

12. The turbine compressor airfoil of claim 1, wherein the sacrificial coating is disposed on the airfoil surface and the erosion-resistant coating is disposed on the sacrificial coating.

13. The turbine compressor airfoil of claim 12, wherein the sacrificial coating comprises a layer of Al, Cr, Zn, an Ni—Al alloy, an Al—Si alloy, an Al-based alloy, a Cr-based alloy or a Zn-based alloy, an Al polymer composite, or a combination thereof, and the erosion-resistant coating comprises a layer of TiN or WCCoCr.

14. The turbine compressor airfoil of claim 12, wherein the sacrificial coating comprises a layer of a conductive undercoat and an overcoat of an inorganic matrix binder having a plurality of ceramic particles and conductive particles embedded therein, and the erosion-resistant coating comprises a layer of TiN or WCCoCr.

15. The turbine compressor airfoil of claim 1, wherein the erosion-resistant coating is disposed on the airfoil surface and the sacrificial coating is disposed on the erosion-resistant coating.

16. The turbine compressor airfoil of claim 15, wherein the erosion-resistant coating comprises a layer of TiN or WCCoCr and the sacrificial coating comprises a layer of a conductive undercoat and an overcoat of an inorganic matrix binder having a plurality of ceramic particles and conductive particles embedded therein.

17. The turbine compressor airfoil of claim 15, wherein the erosion-resistant coating comprises a layer of TiN or WCCoCr and the sacrificial coating comprises a layer of Al, Cr, Zn, an Ni—Al alloy, an Al—Si alloy, an Al-based alloy, a Cr-based alloy or a Zn-based alloy, an Al polymer composite, or a combination thereof.

18. A method of making a turbine compressor airfoil, comprising:
providing a turbine compressor airfoil having an airfoil surface;
disposing one of a sacrificial coating or an erosion-resistant coating on the airfoil surface, the sacrificial coating comprising a layer of Al, Cr, Zn, an Ni—Al alloy, an Al—Si alloy, an Al-based alloy, a Cr-based alloy or a Zn-based alloy, an Al polymer composite, or a combination thereof, or a layer of a conductive undercoat and an overcoat of an inorganic matrix binder having a plurality of ceramic particles and conductive particles embedded therein disposed on the undercoat; and
disposing the other of the sacrificial coating or the erosion-resistant coating on the respective one that is disposed on the airfoil surface, wherein the corrosion resistant coating is more anodic with reference to the airfoil surface than the erosion-resistant coating.

19. The method of claim 18, wherein disposing the sacrificial coating produces a residual compressive stress in the sacrificial coating.

20. The method of claim 18, wherein disposing the erosion-resistant coating produces a residual compressive stress in the erosion-resistant coating.
